(19) United States
(12) Patent Application Publication
(10) Pub. No.: US 2017/0222533 A1
(43) Pub. Date: Aug. 3, 2017

(54) RESETTABLE LINEAR RESONANT ACTUATOR

(71) Applicant: TOPRAY MEMS INC., Hsinchu City (TW)

(72) Inventors: Chin-Sung LIU, Hsinchu City (TW); Hsiao-Ming CHIEN, Hsinchu City (TW)

(73) Assignee: TOPRAY MEMS INC., Hsinchu City (TW)

(21) Appl. No.: 15/159,295

(22) Filed: May 19, 2016

(30) Foreign Application Priority Data
Jan. 29, 2016 (TW) 105201480

(51) Int. Cl. H02K 33/16; H02K 1/34

(52) U.S. Cl. CPC H02K 33/16; H02K 1/34

(57) ABSTRACT

A resettable linear resonant actuator is disclosed, including: a magnet set, a coil and a first magnetic induction element. The magnet set includes first and second magnets. The first side of first magnet contacts the second side of second magnet. The top and bottom surfaces of first and second magnets are at the same level respectively. The first magnet has N pole at top surface and S pole at bottom, while the second magnet has the opposite. The first coil is disposed above or below magnet set and corresponds to contact between the first magnet and second magnet. The first magnetic induction element is disposed at first coil and corresponds to the contact between first magnet and second magnet. With electricity running in first coil, the movable part executes simple harmonic motion by Lorentz force, with electricity off, the movable part returns to the original point by restoration force.

### CROSS-REFERENCE TO RELATED APPLICATION

The present application is based on, and claims priority form, Taiwan Patent Application No. 105201480, filed Jan. 29, 2016, the disclosure of which is hereby incorporated by reference herein in its entirety.

### TECHNICAL FIELD

The technical field generally relates to a linear resonant actuator, and in particular, to a resettable linear resonant actuator based on resonance generated by electromagnetic effect.

### BACKGROUND

The resonance of portable electronic devices, such as, mobile phones or tablet PCs, is generated by a resonant device inside the portable electronic device. The earlier resonant device often relies on eccentric rotating mass (ERM) vibration motor to provide resonance.

Recently, a trend is forming by replacing the ERM vibration motor with a linear resonant actuator to serve as the resonant device. The reason is that the linear resonant actuator utilizes the Lorentz force generated by electromagnetic effect to drive simple harmonic motion to generate resonance, which is fast in response and low in power-consumption.

However, the known linear resonant actuator has the disadvantage that once the electricity is cut off from the coil, the Lorentz force is lost and the movable part will stop immediately and unable to return to original position (i.e., the mechanical origin.)

Hence, it is desirable to provide a linear resonant actuator, wherein the movable part is able to return to original position after the electricity cut off from the coil.

### SUMMARY

The primary object of the present invention is to provide a resettable linear resonant actuator, able to utilize magnetic restoration force to return the movable part to original position after the electricity cut off from the coil.

To achieve the aforementioned objects, the present invention provides a resettable linear resonant actuator, comprising: a magnet set, at least a first coil, and at least a first magnetic induction element.

The magnet set comprises a first magnet, and a second magnet. The first magnet has a top surface, a bottom surface, a first side, and a second side. The first side and the second side of the first magnet are opposite to each other. The second magnet has a top surface, a bottom surface, a first side and a second side. The first side and the second side of the second magnet are opposite to each other. The first side of the first magnet presses against the second side of the second magnet. The top surface of the first magnet and the top surface of the second magnet are at the same level, and the bottom surface of the first magnet and the bottom surface of the second magnet are at the same level, wherein the top surface of the first magnet is an N pole and the bottom surface is an S pole, while the top surface of the second magnet is an S pole and the bottom surface is an N pole.

The first coil is disposed above or below the magnet set and maintains a distance from the magnet set, and corresponds to contact between the first side of the first magnet and the second side of the second magnet.

The first magnetic induction element is disposed at the first coil and corresponds to the contact between the first side of the first magnet and the second side of the second magnet.

According to a preferred embodiment, the first coil has an axis, and the axis of the first coil is respectively perpendicular to the layout direction of the first and the second magnets, and passes the center of the contact between the first side of the first magnet and the second side of the second magnet, as well as passes the axis of the first magnetic induction element. Wherein, the length direction of the magnet set is parallel to the layout direction of the first and the second magnets, and the width direction is perpendicular to the layout direction of the first and the second magnets; the axis of the first coil is perpendicular to the length direction and the width direction of the magnet set; the length and the width of the first coil are smaller than the length and the width of the magnet set respectively. Wherein, the first coil has a top surface and a bottom surface, and the bottom surface of the first coil faces the magnet set. The first magnetic induction element is disposed at the top surface of the first coil. The resettable linear resonant actuator further comprises: an inner sliding track set and an outer sliding track set. The inner sliding track set comprises at least two bases and a plurality of roller balls. The two bases are disposed respectively at the first magnet and the second magnet, and respectively form a plurality of inner side tracks. The roller balls are movably disposed at the plurality of inner side tracks. The outer sliding track set comprises two outer side tracks. The top surface of the first magnetic induction element is fixed to the two outer side tracks, and the roller balls respectively contact the two outer side tracks.

According to a preferred embodiment, the resettable linear resonant actuator further comprises two first coils and two first magnetic induction elements. The two first coils are disposed respectively above and below the magnet set and respectively maintain a distance from the magnet set, and respectively correspond to the contact between the first side of the first magnet and the second side of the second magnet. The two first magnetic induction elements are disposed respectively at the two first coils and correspond to the contact between the first side of the first magnet and the second side of the second magnet. Wherein, the two first coils have the same distance from the magnet set. Wherein, each first coil has an axis, and the axis of the first coil is respectively perpendicular to the layout direction of the first and the second magnets, and passes the center of the contact between the first side of the first magnet and the second side of the second magnet, as well as passes the axis of the two first magnetic induction elements. Wherein, the length direction of the magnet set is parallel to the layout direction of the first and the second magnets, and the width direction is perpendicular to the layout direction of the first and the second magnets; the axis of each of the two first coils is perpendicular to the length direction and the width direction of the magnet set, the two first coils have the same size, and the length and the width of the two first coils are smaller than the length and the width of the magnet set respectively; the two first magnetic induction elements have the same size, and the length and the width of the two first magnetic induction elements are smaller than the length and the width of the two first coils respectively. Wherein, each first coil has a top surface and a bottom surface, and the bottom surface of the two first coils faces the magnet set. The two first magnetic induction elements are respectively disposed at the top surface of the two first coils. The resettable linear resonant actuator further comprises: an inner sliding track set and an outer sliding track set. The inner sliding track set comprises at least two bases and a plurality of roller balls. The two bases are disposed respectively at the first magnet and the second magnet, and respectively form a plurality of inner side tracks. The roller balls are movably disposed at the plurality of inner side tracks. The outer sliding track set comprises two outer side tracks. The top surface of the two first magnetic induction elements is fixed to the two outer side tracks, and the roller balls respectively contact the two outer side tracks.

According to a preferred embodiment, the magnet set further comprises a third magnet, and the third magnet has a top surface, a bottom surface, a first side, and a second side; the first side and the second side of the third magnet are opposite to each other; the first side of the second magnet presses against the second side of the third magnet; the top surface of the second magnet and the top surface of the third magnet are at the same level, and the bottom surface of the second magnet and the bottom surface of the third magnet are at the same level, wherein the top surface of the third magnet is an N pole and the bottom surface is an S pole; wherein the resettable linear resonant actuator further comprises two second coils and two second magnetic induction elements; the two second coils are disposed respectively above and below the magnet set and respectively maintain a distance from the magnet set, and respectively correspond to the contact between the first side of the second magnet and the second side of the third magnet; the two second magnetic induction elements are disposed respectively at the two second coils and correspond to the contact between the first side of the second magnet and the second side of the third magnet. Wherein, each first coil and each second coil have the same distance from the magnet set. Wherein, each first coil and each second coil have an axis, and the axis of the first coil and the second coil is respectively perpendicular to the layout direction of the first, the second and the third magnets; the axis of each first coil passes the center of the contact between the first side of the first magnet and the second side of the second magnet, as well as passes the axis of the two first magnetic induction elements; the axis of each second coil passes the center of the contact between the first side of the second magnet and the second side of the third magnet, as well as passes the axis of the two second magnetic induction elements; Wherein, the length direction of the magnet set is parallel to the layout direction of the first, the second and the third magnets, and the width direction is perpendicular to the layout direction of the first, the second and the third magnets; the axis of each of the two first coils and the two second coils is perpendicular to the length direction and the width direction of the magnet set; the two first coils and the two second coils have the same size, and the length and the width of the two first coils and the two second coils are smaller than the length and the width of the magnet set respectively; the two first magnetic induction elements and the two second magnetic induction elements have the same size, and the length and the width of the two first magnetic induction elements and the two second magnetic induction elements are smaller than the length and the width of the two first coils and the two second coils, respectively. Wherein, each of the two first coils and the two second coils has a top surface and a bottom surface, and the bottom surface of each of the two first coils and the two second coils faces the magnet set. The two first magnetic induction elements are respectively disposed at the top surface of the two first coils; the two second magnetic induction elements are respectively disposed at the top surface of the two second coils. The resettable linear resonant actuator further comprises: an inner sliding track set and an outer sliding track set. The inner sliding track set comprises at least two bases and a plurality of roller balls. The two bases are disposed respectively at the first magnet and the third magnet, and respectively form a plurality of inner side tracks. The roller balls are movably disposed at the plurality of inner side tracks. The outer sliding track set comprises two outer side tracks. The top surface of the two first magnetic induction elements is fixed to the two outer side tracks, the top surface of the two second magnetic induction elements is fixed to the two outer side tracks, and the roller balls respectively contact the two outer side tracks, wherein the neighboring first and second coils maintain a distance and the distance is less than the distance between the first side and the second side of the second magnet.

The advantages of the present invention lies in that, when the electricity runs in the coils, the movable part formed by the magnet set and the inner sliding track set can move through the steady and balanced Lorentz force with respect to the fixed part formed by the coils, magnetic induction elements and the outer sliding track set in a steady simple harmonic motion manner. After the electricity is cut off from the coil, the movable part is able to return to original position (i.e., mechanical origin) by the restoration force (the magnetic restoration force combined with the magnetic levitation force and stays stationary.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of a first embodiment of the resettable linear resonant actuator in accordance with an exemplary embodiment;

FIG. 2 shows a dissected view of the first embodiment of the resettable linear resonant actuator in accordance with an exemplary embodiment;

FIG. 3 shows a schematic view of the first embodiment of the resettable linear resonant actuator, including inner sliding track set and outer sliding track set in accordance with an exemplary embodiment;

FIG. 4 shows a schematic view of the first embodiment of the resettable linear resonant actuator, including inner sliding track set in accordance with an exemplary embodiment;

FIG. 5 shows a dissected view of the first embodiment of the resettable linear resonant actuator, including inner sliding track set in accordance with an exemplary embodiment;

FIG. 6 shows a schematic view of the magnetic line distribution of the first embodiment of the resettable linear resonant actuator in accordance with an exemplary embodiment;

FIG. 7 shows a schematic view of the first embodiment of the resettable linear resonant actuator with the movable part moving left with respect to the fixed part in accordance with an exemplary embodiment;

FIG. 8 shows a schematic view of the first embodiment of the resettable linear resonant actuator with the movable part moving right with respect to the fixed part in accordance with an exemplary embodiment;

FIG. 9 shows a schematic view of the first embodiment of the resettable linear resonant actuator, after the electricity is cut off from the first coil, the movable part returning to original position by the pushing force of the magnetic restoration force in accordance with an exemplary embodiment;

FIG. 10 shows a schematic view of a second embodiment of the resettable linear resonant actuator in accordance with an exemplary embodiment; and

FIG. 11 shows a side view of the second embodiment of the resettable linear resonant actuator in accordance with an exemplary embodiment.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

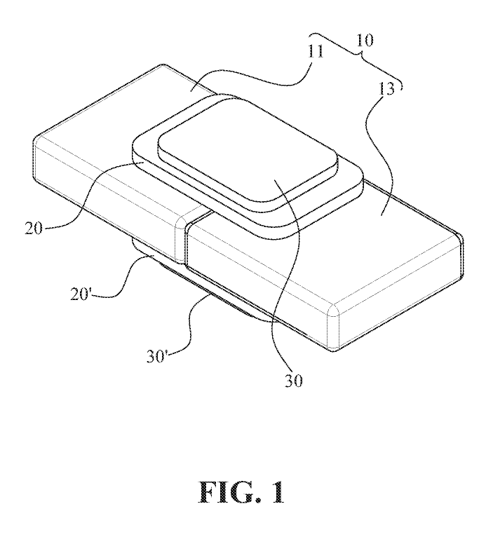

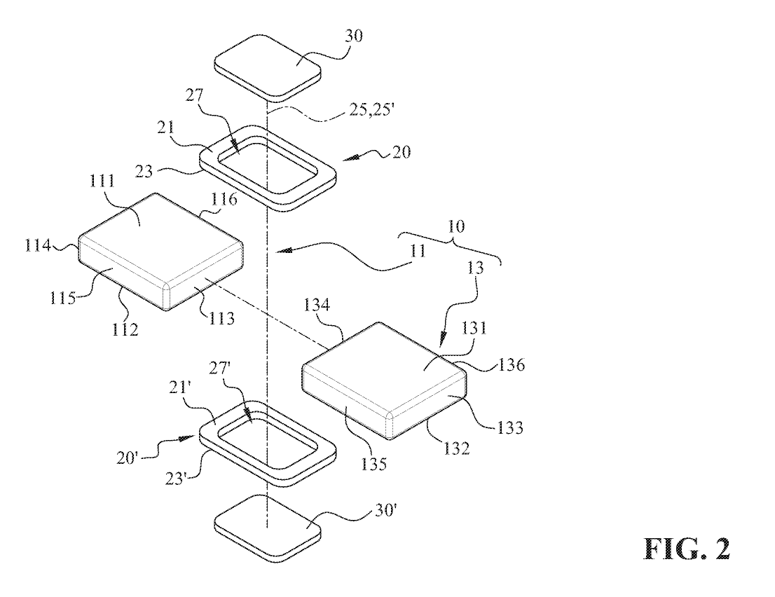

Refer to FIGS. 1-2. FIG. 1 shows a schematic view of a first embodiment of the resettable linear resonant actuator in accordance with an exemplary embodiment; and FIG. 2 shows a dissected view of the first embodiment of the resettable linear resonant actuator in accordance with an exemplary embodiment. The present invention provides a resettable linear resonant actuator, comprising: a magnet set 10, two first coils 20, and two first magnetic induction elements 30.

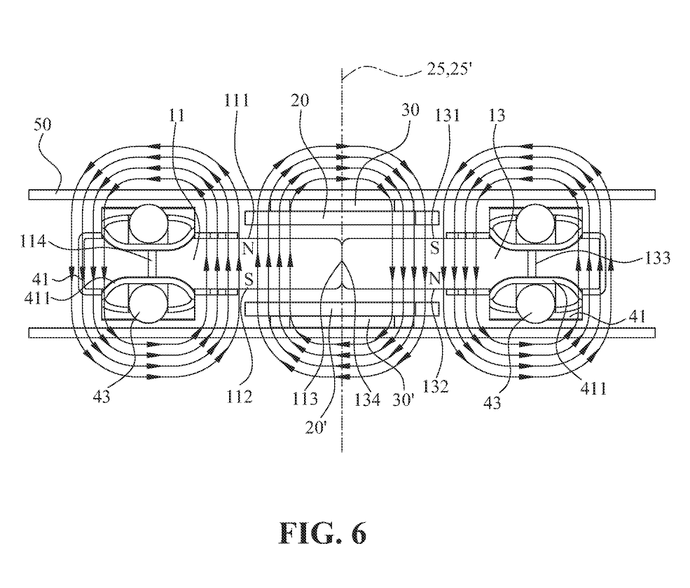

The magnet set 10 comprises a first magnet 11, and a second magnet 13. The first magnet 11 has a top surface 111, a bottom surface 112, a first side 113, a second side 114, a third side 115, and a fourth side 116. The first side 113 and the second side 114 of the first magnet 11 are opposite to each other. The third side 115 and the fourth side 116 of the first magnet 11 are opposite to each other. The second magnet 13 has a top surface 131, a bottom surface 132, a first side 133, a second side 134, a third side 135, and a fourth side 136. The first side 133 and the second side 134 of the second magnet 13 are opposite to each other. The third side 135 and the fourth side 136 of the second magnet 13 are opposite to each other. The first side 113 of the first magnet 11 presses against the second side 134 of the second magnet 13. The top surface 111 of the first magnet 11 and the top surface 131 of the second magnet 13 are at the same level, and the bottom surface 112 of the first magnet 11 and the bottom surface 132 of the second magnet 13 are at the same level, wherein the top surface 111 of the first magnet 11 is an N pole and the bottom surface 112 is an S pole, while the top surface 131 of the second magnet 13 is an S pole and the bottom surface 132 is an N pole, as shown in FIG. 6. In other words, the N pole of the first magnet 11 and the S pole of the second magnet 13 are at the same level; the S pole of the first magnet 11 and the N pole of the second magnet 13 are at the same level. As such, the first magnet 11 and the second magnet 13 are attracted to each other, wherein the first magnet 11 and the second magnet 13 are cuboids of the same size. In other words, the first magnet 11 and the second magnet 13 have the same length, width and height. Wherein, the length direction of the magnet set 10 is parallel to the layout direction of the first magnet 11 and the second magnet 13, and the width direction of the magnet set 10 is perpendicular to the layout direction of the first magnet 11 and the second magnet 13.

The first coils 20, 20′ are disposed respectively above and below the magnet set 10 and maintain a distance from the magnet set 10, and correspond to contact between the first side 113 of the first magnet 11 and the second side 134 of the second magnet 13. In the present embodiment, the first coils 20, 20′ have the same distance from the magnet set 10. Each first coil 20, 20′ has a top surface 21, 21′, a bottom surface 23, 23′, and an axis 25, 25′. The bottom surface 23, 23′ of the first coil 20, 20′ faces the magnet set 10, and the axis 25, 25′ of the first coil 20, 20′ is perpendicular to the layout direction of the first magnet 11 and the second magnet 13, and passes the center of the contact between the first side 113 of the first magnet 11 and the second side 134 of the second magnet. In other words, the axis 25, 25′ of the first coil 20, 20′ is perpendicular to the length direction and the width direction of the magnet set 10. Preferably, the two first coils 20, 20′ have the same size, and the length and the width of the two first coils 20, 20′ are smaller than the length and the width of the magnet set 10, respectively. In other words, the first coils 20, 20′ are disposed symmetrically above and below the magnet set 10. In other embodiments, the resettable linear resonance actuator may include only one first coil 20.

The two first magnetic induction elements 30, 30′ are disposed respectively at the first coils 20, 20′ and correspond to the contact between the first side 113 of the first magnet 11 and the second side 134 of the second magnet 13. Preferably, the axis 25, 25′ of the first coil 20, 20′ passes the axis of the two first magnetic induction elements 30, 30′ respectively. The two first magnetic induction elements 30, 30′ have the same size, and the length and the width of the two first magnetic induction elements 30, 30′ are smaller than the length and the width of the two first coils 20, 20′, respectively. The two first magnetic induction elements 30, 30′ are respectively disposed at the top surface 21, 21′ of the two first coils 20, 20′. Specifically, each first coil 20, 20′ surrounds to form an axis hole 27, 27′. The length and the width of the first magnetic induction element 30, 30′ are greater than the inner diameter of the axis hole 27, 27′ of the first coil 20, 20′. Therefore, the first magnetic induction element 30, 30′ can be fixed to the top surface 21, 21′ of the first coil 20, 20′. In other embodiments, the resettable linear resonance actuator may also include only a first magnetic induction element 30.

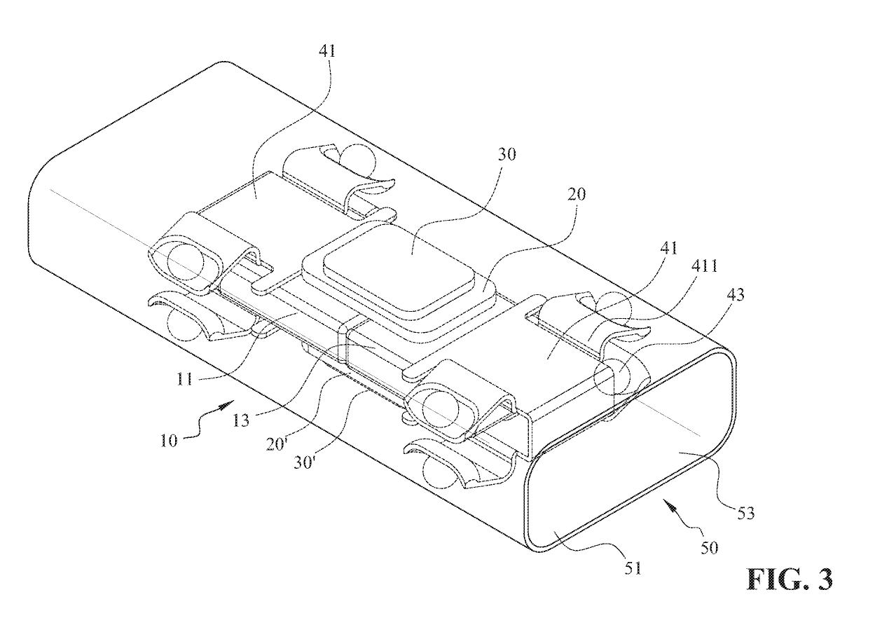

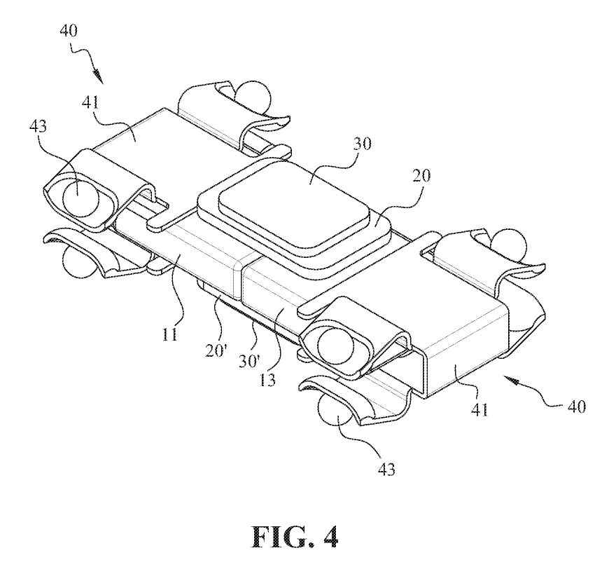

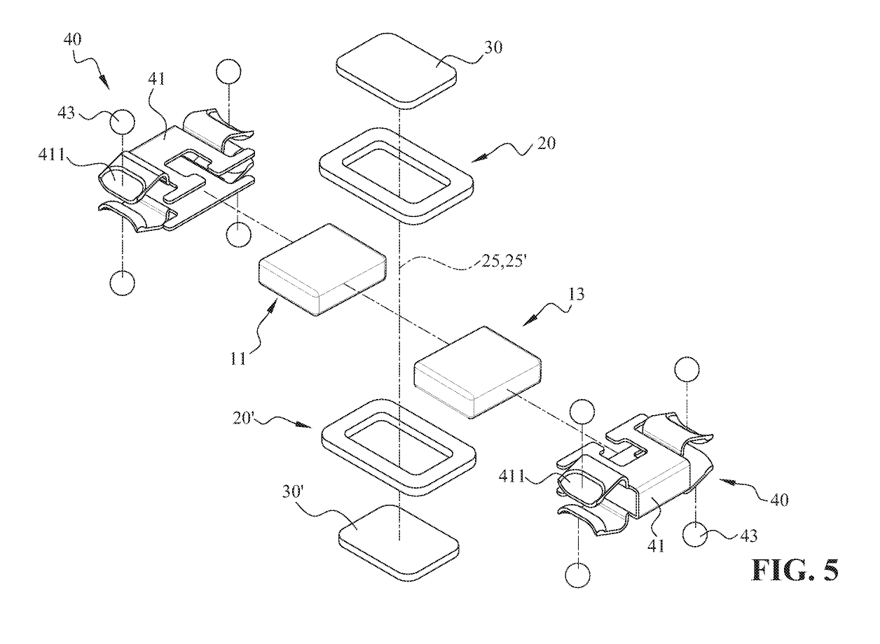

Refer to FIGS. 3-5. FIG. 3 shows a schematic view of the first embodiment of the resettable linear resonant actuator, including inner sliding track set and outer sliding track set in accordance with an exemplary embodiment; FIG. 4 shows a schematic view of the first embodiment of the resettable linear resonant actuator, including inner sliding track set in accordance with an exemplary embodiment; and FIG. 5 shows a dissected view of the first embodiment of the resettable linear resonant actuator, including inner sliding track set in accordance with an exemplary embodiment. The resettable linear resonant actuator further includes an inner sliding track set 40 and an outer sliding track set 50. The inner sliding track set 40 comprises at least two bases 41 and a plurality of roller balls 43. The two bases 41 are disposed respectively at the first magnet 11 and the second magnet 13, and respectively form a plurality of inner side tracks 411. The roller balls 43 are movably disposed at the plurality of inner side tracks 411. The outer sliding track set 50 comprises two outer side tracks 51, 53. The top surface 21, 21′ of the two first magnetic induction elements 30, 30′ is fixed to the two outer side tracks 51, 53. In the present embodiment, the inner sliding track set 40 comprises eight roller balls 43, and each base 41 forms two inner side tracks 411 on two sides respectively. The two inner side tracks 411 are disposed corresponding to each other in upper and lower positions respectively. As such, the magnet set 10 and the inner sliding track set 40 form a movable part. The two first coils 20, 20′, the two first magnetic induction elements 30, 30′, and the outer sliding track set 50 form a fixed part. Four roller balls 43 located at one side of the movable part contact one of the outer side track 51, and the other four roller balls 43 located at the other side of the movable part contact the other outer side track 53.

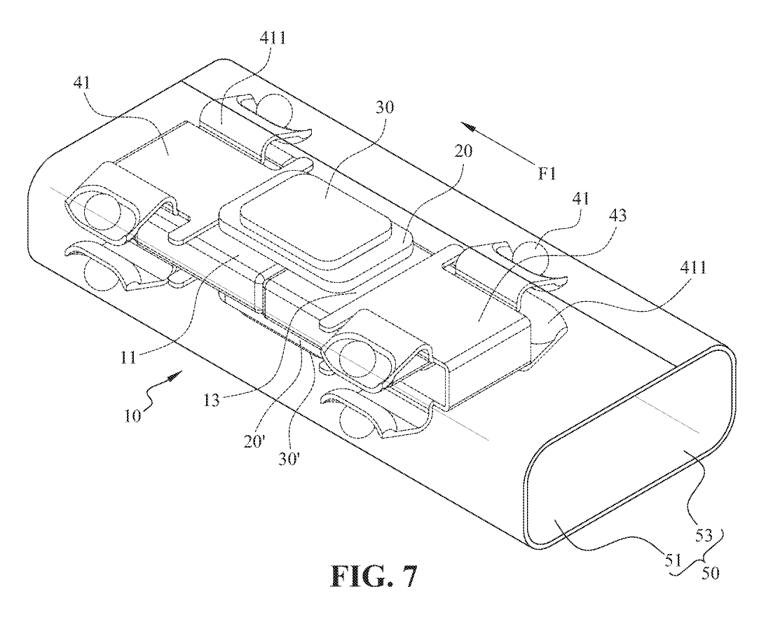

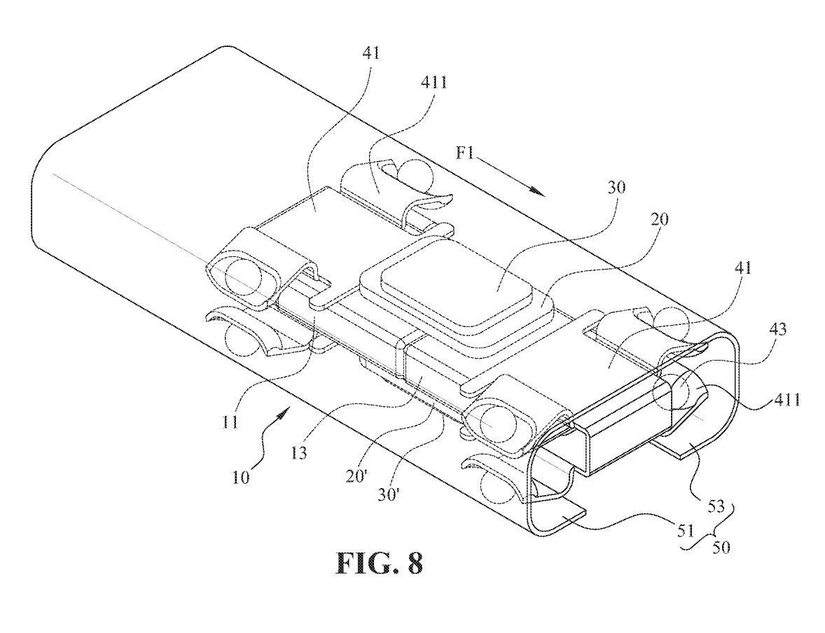

Refer to FIGS. 6-8. FIG. 6 shows a schematic view of the magnetic line distribution of the first embodiment of the resettable linear resonant actuator in accordance with an exemplary embodiment; FIG. 7 shows a schematic view of the first embodiment of the resettable linear resonant actuator with the movable part moving left with respect to the fixed part in accordance with an exemplary embodiment; and FIG. 8 shows a schematic view of the first embodiment of the resettable linear resonant actuator with the movable part moving right with respect to the fixed part in accordance with an exemplary embodiment. When the electricity runs through the first coils 20, 20′ continuously in alternating directions, the current through the first coils 20, 20′ interacts with the magnetic field coming out of the magnet set 10 to generate Lorentz force F1. As such, the movable part can move to left and right with respect to the fixed part in the layout direction of the magnet set 10 in a simple harmonic motion manner, as shown in FIGS. 7 and 8.

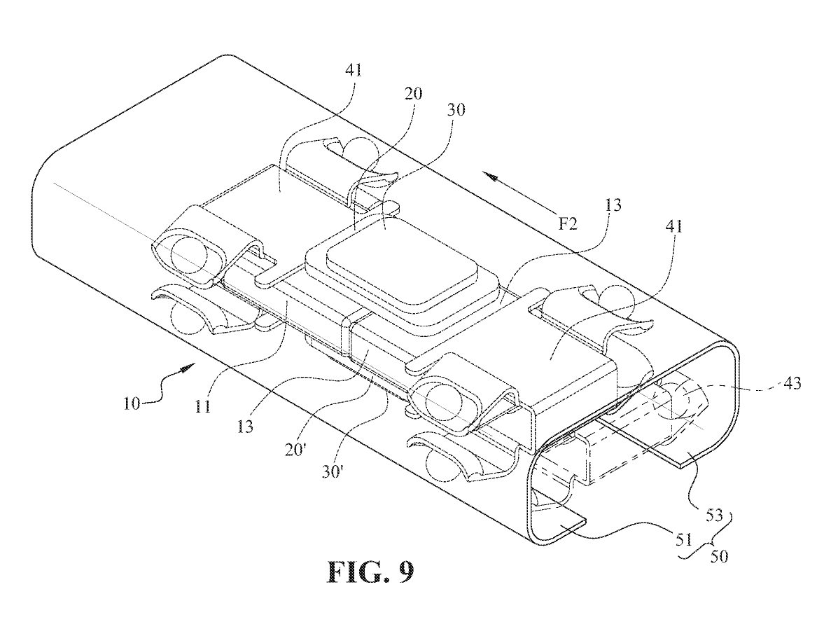

Refer to FIG. 9. FIG. 9 shows a schematic view of the first embodiment of the resettable linear resonant actuator, after the electricity is cut off from the first coil, the movable part returning to original position by the pushing force of the magnetic restoration force in accordance with an exemplary embodiment. Wherein, when the movable part executes simple harmonic motion with respect to the fixed part, a magnetic restoration force and a magnetic levitation force can be generated between the first and the second magnets 11, 13 of the magnet set 10 and the first magnetic induction elements 30, 30′. The magnetic restoration force combined with the magnetic levitation force can be referred to as restoration force F2 (also called as the magnetic spring.) In general, the Lorentz force F1 is greater than the restoration force F2. Hence, when the electricity passes through the first coils 20, 20′ continuously in alternating directions, the movable part is affected by the Lorentz force F1 to execute simple harmonic motion with respect to the fixed part. When the electricity is cut off from the first coils 20, 20′, the Lorentz force F1 disappears immediately, and the movable part is no longer affected by the Lorentz force F1. As such, the magnetic restoration force of the restoration force F2 can immediately push the movable part to the original position (i.e., the mechanical origin), and then the magnetic levitation force of the restoration force F2 keeps the movable part stay at the original position, so that the axis 25, 25′ of the first coil 20, 20′ can be again aligned with and passes through the center of the contact between the first side 113 of the first magnet 11 and the second side 134 of the second magnet 13.

The features of the first embodiment of the resettable linear resonance actuator lie in that the first magnet 11 and the second magnet 13 are pressed together and are laid out in polar attraction manner; the first coils 20, 20′ respectively maintain a distance from above and below the magnet set 10 and correspond to the contact side of the first magnet 11 and the second magnet 13, the first magnetic induction elements 30, 30′ are disposed respectively at the first coils 20, 20′ and correspond to the contact side of the first magnet 11 and the second magnet 13. As such, the present invention can generate steady and balanced Lorentz force F1 and restoration force F2. When the electricity runs through the first coils 20, 20′, the movable is able to execute simple harmonic motion through the steady and balanced Lorentz force F1, and after the electricity is cut off from the first coils 20, 20′, the movable part can return to and stay at the original position through the steady and balanced restoration force.

Moreover, when the first coils 20, 20′ have the same distance from the magnet set 10, the Lorentz force F1 and the restoration force F2 are more steady and more balanced.

Furthermore, when the axis 25, 25′ of the first coils 20, 20′ passes the center of the contact between the first side 113 of the first magnet 11 and the second side 134 of the second magnet 13, as well as the axis of the first magnetic induction elements 30, 30′, the Lorentz force F1 and the restoration force F2 are more steady and more balanced.

Also, when the first coils 20, 20′ have the same size and the first magnetic induction elements 30, 30′ have the same size, the Lorentz force F1 and the restoration force F2 are more steady and more balanced.

In practice, the resettable linear resonance actuator of the present invention can includes only a first coil 20 and a first magnetic induction element 30 to provide the Lorentz force F1 and the restoration force F2, with a slightly decrease in effectiveness.

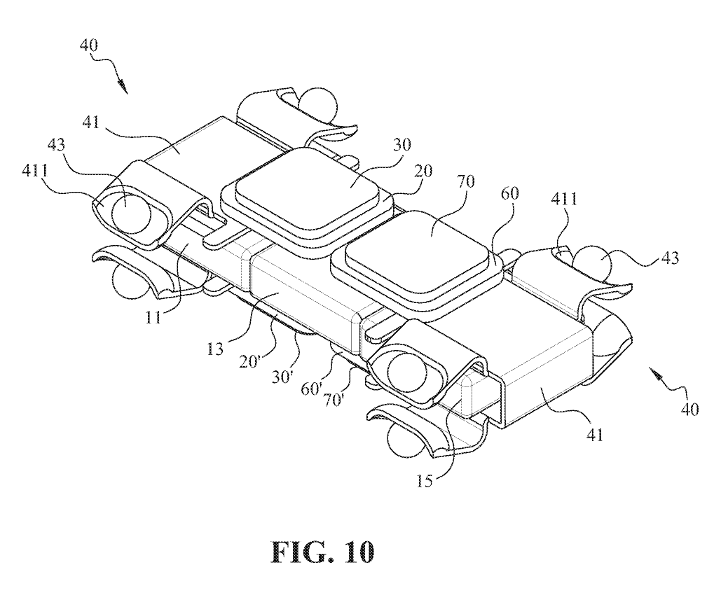

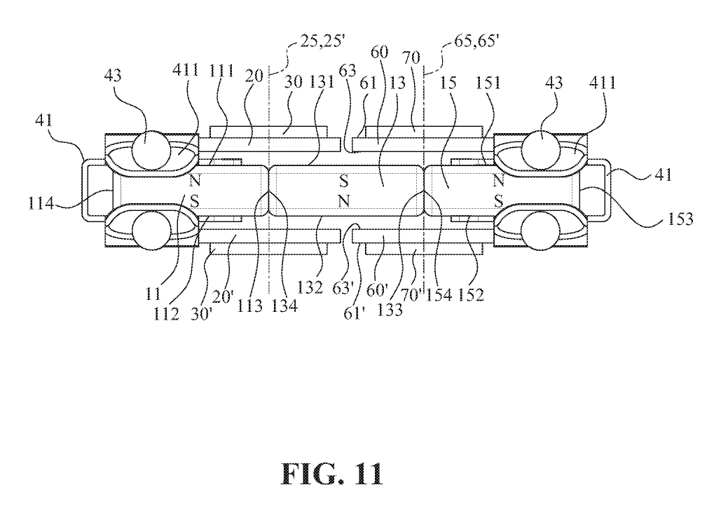

Refer to FIGS. 10-11. FIG. 10 shows a schematic view of a second embodiment of the resettable linear resonant actuator in accordance with an exemplary embodiment; and FIG. 11 shows a side view of the second embodiment of the resettable linear resonant actuator in accordance with an exemplary embodiment. The second embodiment differs from the first embodiment in that the second embodiment further includes two second coils 60, 60′, two second magnetic induction elements 70, 70′ and the magnet set 10 further comprises a third magnet 15.

Specifically, the third magnet 15 has a top surface 151, a bottom surface 152, a first side 153, a second side 154, a third side 155, and a fourth side 156; the first side 153 and the second side 154 of the third magnet 15 are opposite to each other, and the third side 155 and the fourth side 156 of the third magnet 15 are opposite to each other. The first side 133 of the second magnet 13 presses against the second side 154 of the third magnet 15; the top surface 131 of the second magnet 13 and the top surface 151 of the third magnet 15 are at the same level, and the bottom surface 132 of the second magnet 13 and the bottom surface 152 of the third magnet 15 are at the same level. Wherein, the top surface 151 of the third magnet 15 is an N pole and the bottom surface 152 is an S pole. In other words, the N pole of the third magnet 15 is at the same level as the S pole of the second magnet 13 and the N pole of the first magnet 11, and the S pole of the third magnet 15 is at the same level as the N pole of the second magnet 13 and the S pole of the first magnet 11. As such, the second magnet 13 and the third magnet 15 are attracted to each other. Wherein, the third magnet 15 is a cuboid of the same size as the first magnet 11 and the second magnet 13. In other words, the third magnet 15 has the same length, width and height as the first magnet 1 and the second magnet 13. Wherein, the length direction of the magnet set 10 is parallel to the layout direction of the first magnet 11, the second magnet 13 and the third magnet 15; and the width direction of the magnet set 10 is perpendicular to the layout direction of the first magnet 11, the second magnet 13 and the third magnet 15.

The two second coils 60, 60′ are disposed respectively above and below the magnet set 10 and respectively maintain a distance from the magnet set 10, and respectively correspond to the contact between the first side 133 of the second magnet 13 and the second side 154 of the third magnet 15. In the present embodiment, Wherein, each first coil 20, 20′ and each second coil 60, 60′ have the same distance from the magnet set. Each second coil 60, 60′ has a top surface 61, 61′, a bottom surface 63, 63′, and an axis 65, 65′. The bottom surface 63, 63′ of the second coil 60, 60′ faces the magnet set 10, and the axis 65, 65′ of the second coil 60, 60′ is perpendicular to the layout direction of the first magnet 11, the second magnet 13 and the third magnet 15, and passes the center of the contact between the first side 133 of the second magnet 13 and the second side 154 of the third magnet 15. In other words, the axis 65, 65′ of the second coil 60, 60′ is perpendicular to the length direction and the width direction of the magnet set 10. Preferably, the two second coils 60, 60′ have the same size, and the length and the width of the two second coils 60, 60′ are smaller than the length and the width of the magnet set 10, respectively. In other words, the second coils 60, 60′ are disposed symmetrically above and below the magnet set 10. Wherein, the neighboring first coil 20 and the second coil 60 and the neighboring first coil 20′ and the second coil 60′ maintain a distance, and the distance is less than the distance between the first side 133 and the second side 134 of the second magnet 13.

The two second magnetic induction elements 70, 70′ are disposed respectively at the second coils 60, 60′ and correspond to the contact between the first side 133 of the second magnet 13 and the second side 154 of the third magnet 15. Preferably, the axis 65, 65′ of the second coil 60, 60′ passes the axis of the two second magnetic induction elements 70, 70′ respectively. The two first magnetic induction elements 30, 30′ and the second magnetic induction elements 70, 70′ have the same size, and the length and the width of the two second magnetic induction elements 70, 70′ are smaller than the length and the width of the two second coils 60, 60′, respectively. The two second magnetic induction elements 70, 70′ are respectively disposed at the top surface 61, 61′ of the two second coils 60, 60′. Specifically, each second coil 60, 60′ surrounds to form an axis hole (not shown). The length and the width of the second magnetic induction element 70, 70′ are greater than the inner diameter of the axis hole of the second coil 60, 60′. Therefore, the second magnetic induction element 70, 70′ can be fixed to the top surface 61, 61′ of the second coil 60, 60′.

The bases 41 are disposed respectively at the first magnet 11 and the third magnet 13, and the top surface of the second magnetic induction elements 70, 70′ is fixed to the outer sliding track set 50.

Wherein, the magnet set 10 and the inner sliding track set 40 form the movable part, and the first coils 20, 20′, the second coils 60, 60′, the first magnetic induction elements 30, 30′, the second magnetic induction elements 70, 70′, and the outer sliding track set 50 form the fixed part.

During the use of the second embodiment of the present invention, when the electricity runs through the first coils 20, 20′ and the second coils 60, 60′ continuously in alternating directions, the current through the first coils 20, 20′ and the second coils 60, 60′ interacts with the magnetic field coming out of the magnet set 10 to generate Lorentz force F1. As such, the movable part can move to left and right with respect to the fixed part in the layout direction of the magnet set 10 in a simple harmonic motion manner.

When the electricity is cut off from the first coils 20, 20′ and the second coils 60, 60′, the Lorentz force F1 disappears immediately, and the movable part is no longer affected by the Lorentz force F1. As such, the magnetic restoration force of the restoration force F2 can immediately push the movable part to the original position, and then the magnetic levitation force of the restoration force F2 keeps the movable part stay at the original position, so that the axis 25, 25′ of the first coil 20, 20′ can be again aligned with and passes through the center of the contact between the first side 113 of the first magnet 11 and the second side 134 of the second magnet 13, and the axis 65, 65′ of the second coil 60, 60′ can be again aligned with and passes through the center of the contact between the first side 133 of the second magnet 13 and the second side 154 of the third magnet 15.

In summary, the second embodiment is an exemplar with increased number of the magnets of the magnet set, number of coils and number of magnetic induction elements, so that the generated Lorentz force F1 and the restoration force F2 are greater than the first embodiment. In other words, by increasing the number of magnets of the magnet set, the coils and the magnetic induction elements in the resettable linear resonance actuator, the present invention can generate higher Lorentz force F1 and restoration force F2.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A resettable linear resonance actuator, comprising:
a magnet set, comprising a first magnet, and a second magnet, the first magnet having a top surface, a bottom surface, a first side, and a second side; the first side and the second side of the first magnet being disposed opposite to each other; the second magnet having a top surface, a bottom surface, a first side and a second side, the first side and the second side of the second magnet being disposed opposite to each other; the first side of the first magnet pressing against the second side of the second magnet, the top surface of the first magnet and the top surface of the second magnet being at the same level, and the bottom surface of the first magnet and the bottom surface of the second magnet being at the same level, wherein the top surface of the first magnet being an N pole and the bottom surface being an S pole, while the top surface of the second magnet being an S pole and the bottom surface being an N pole;
at least a first coil, disposed above or below the magnet set and maintaining a distance from the magnet set, and corresponding to contact between the first side of the first magnet and the second side of the second magnet; and
at least a first magnetic induction element, disposed at the first coil, and corresponding to the contact between the first side of the first magnet and the second side of the second magnet.

2. The resettable linear resonance actuator as claimed in claim 1, wherein the first coil has an axis, and the axis of the first coil is respectively perpendicular to the direction that the first and the second magnets are laid out, and passes the center of the contact between the first side of the first magnet and the second side of the second magnet, as well as passes the axis of the first magnetic induction element.

3. The resettable linear resonance actuator as claimed in claim 2, wherein the length direction of the magnet set is parallel to the layout direction of the first and the second magnets, and the width direction is perpendicular to the layout direction of the first and the second magnets; the axis of the first coil is perpendicular to the length direction and the width direction of the magnet set; the length and the width of the first coil are smaller than the length and the width of the magnet set respectively.

4. The resettable linear resonance actuator as claimed in claim 3, wherein the length and the width of the first magnetic induction element are smaller than the length and the width of the first coil respectively.

5. The resettable linear resonance actuator as claimed in claim 1, wherein the first coil has a top surface and a bottom surface, and the bottom surface of the first coil faces the magnet set, and the first magnetic induction element is disposed at the top surface of the first coil.

6. The resettable linear resonance actuator as claimed in claim 5, further comprising an inner sliding track set and an outer sliding track set, the inner sliding track set comprising at least two bases and a plurality of roller balls, the two bases being disposed respectively at the first magnet and the second magnet, and respectively forming a plurality of inner side tracks; the roller balls being movably disposed at the plurality of inner side tracks; the outer sliding track set comprising two outer side tracks; the top surface of the first magnetic induction element being fixed to the two outer side tracks, and the roller balls respectively contacting the two outer side tracks.

7. The resettable linear resonance actuator as claimed in claim 1, wherein the resettable linear resonance actuator comprises two first coils and two first magnetic induction elements; the two first coils are disposed respectively above and below the magnet set and respectively maintain a distance from the magnet set, and respectively correspond to the contact between the first side of the first magnet and the second side of the second magnet; the two first magnetic induction elements are disposed respectively at the two first coils and correspond to the contact between the first side of the first magnet and the second side of the second magnet.

8. The resettable linear resonance actuator as claimed in claim 7, wherein the two first coils have the same distance from the magnet set.

9. The resettable linear resonance actuator as claimed in claim 8, wherein each first coil has an axis, and the axis of each first coil is respectively perpendicular to the layout direction of the first and the second magnets, and passes the center of the contact between the first side of the first magnet and the second side of the second magnet, as well as passes the axis of the two first magnetic induction elements.

10. The resettable linear resonance actuator as claimed in claim 9, wherein the length direction of the magnet set is parallel to the layout direction of the first and the second magnets, and the width direction is perpendicular to the layout direction of the first and the second magnets; the axis of each of the two first coils is perpendicular to the length direction and the width direction of the magnet set; the two first coils have the same size, and the length and the width of the two first coils are smaller than the length and the width of the magnet set respectively.

11. The resettable linear resonance actuator as claimed in claim 10, wherein the two first magnetic induction elements have the same size, and the length and the width of the two first magnetic induction elements are smaller than the length and the width of the two first coils respectively.

12. The resettable linear resonance actuator as claimed in claim 7, wherein each first coil has a top surface and a bottom surface, and the bottom surface of each of the two first coils faces the magnet set; the two first magnetic induction elements are respectively disposed at the top surface of the two first coils.

13. The resettable linear resonance actuator as claimed in claim 12, further comprising: an inner sliding track set and an outer sliding track set; the inner sliding track set comprising at least two bases and a plurality of roller balls; the two bases being disposed respectively at the first magnet and the second magnet, and respectively forming a plurality of inner side tracks; the roller balls being movably disposed at the plurality of inner side tracks; the outer sliding track set comprising two outer side tracks; the top surface of the two first magnetic induction elements being fixed to the two outer side tracks, and the roller balls respectively contacting the two outer side tracks.

14. The resettable linear resonance actuator as claimed in claim 13, wherein the magnet set further comprises a third magnet, and the third magnet has a top surface, a bottom surface, a first side, and a second side; the first side and the second side of the third magnet are opposite to each other; the first side of the second magnet presses against the second side of the third magnet; the top surface of the second magnet and the top surface of the third magnet are at the same level, and the bottom surface of the second magnet and the bottom surface of the third magnet are at the same level, wherein the top surface of the third magnet is an N pole and the bottom surface is an S pole; wherein the resettable linear resonant actuator further comprises two second coils and two second magnetic induction elements; the two second coils are disposed respectively above and below the magnet set and respectively maintain a distance from the magnet set, and respectively correspond to the contact between the first side of the second magnet and the second side of the third magnet; the two second magnetic induction elements are disposed respectively at the two second coils and correspond to the contact between the first side of the second magnet and the second side of the third magnet.

15. The resettable linear resonance actuator as claimed in claim 14, wherein each first coil and each second coil have the same distance from the magnet set.

16. The resettable linear resonance actuator as claimed in claim 15, wherein each first coil and each second coil have an axis, and the axis of each of the first coils and the second coils is respectively perpendicular to the layout direction of the first, the second and the third magnets; the axis of each first coil passes the center of the contact between the first side of the first magnet and the second side of the second magnet, as well as passes the axis of the two first magnetic induction elements; the axis of each second coil passes the center of the contact between the first side of the second magnet and the second side of the third magnet, as well as passes the axis of the two second magnetic induction elements.

17. The resettable linear resonance actuator as claimed in claim 16, wherein the length direction of the magnet set is parallel to the layout direction of the first, the second and the third magnets, and the width direction is perpendicular to the layout direction of the first, the second and the third magnets; the axis of each of the two first coils and the two second coils is perpendicular to the length direction and the width direction of the magnet set; the two first coils and the two second coils have the same size, and the length and the width of the two first coils and the two second coils are smaller than the length and the width of the magnet set respectively.

18. The resettable linear resonance actuator as claimed in claim 17, wherein the two first magnetic induction elements and the two second magnetic induction elements have the same size, and the length and the width of the two first magnetic induction elements and the two second magnetic induction elements are smaller than the length and the width of the two first coils and the two second coils, respectively.

19. The resettable linear resonance actuator as claimed in claim 14, wherein each of the two first coils and the two second coils has a top surface and a bottom surface, and the bottom surface of each of the two first coils and the two second coils faces the magnet set; the two first magnetic induction elements are respectively disposed at the top surface of the two first coils; the two second magnetic induction elements are respectively disposed at the top surface of the two second coils.

20. The resettable linear resonance actuator as claimed in claim 19, further comprising an inner sliding track set and an outer sliding track set; the inner sliding track set comprising at least two bases and a plurality of roller balls; the two bases being disposed respectively at the first magnet and the third magnet, and respectively forming a plurality of inner side tracks; the roller balls being movably disposed at the plurality of inner side tracks; the outer sliding track set comprising two outer side tracks; the top surface of the two first magnetic induction elements being fixed to the two outer side tracks, the top surface of the two second magnetic induction elements being fixed to the two outer side tracks, and the roller balls respectively contacting the two outer side tracks.

21. The resettable linear resonance actuator as claimed in claim 1, wherein the neighboring first and second coils maintain a distance and the distance is less than the distance between the first side and the second side of the second magnet.
